(19) United States
(12) Patent Application Publication
(10) Pub. No.: US 2014/0156370 A1
(43) Pub. Date: Jun. 5, 2014

(54) SYSTEMS AND METHODS FOR PROCESSING COUPONS OVER A PAYMENT PROCESSING NETWORK

(71) Applicant: CCE CREDIT CARD ENTERPRISES, INC., Edwardsville, IL (US)

(72) Inventors: Michael Gerard Vaughan, Bellmore, NY (US); James Francis Vaughan, Carlsbad, CA (US); Richard Henry Schmid, Roswell, GA (US); William Richard Restis, La Mirada, CA (US); William Richard Restis, II, San Diego, CA (US); Patrick Scott Lay, Edwardsville, IL (US)

(73) Assignee: CCE CREDIT CARD ENTERPRISES, INC., Edwardsville, IL (US)

(21) Appl. No.: 13/705,129

(22) Filed: Dec. 4, 2012

(51) Int. Cl. G06Q 30/02

(52) U.S. Cl. CPC G06Q 30/0222
USPC 705/14.23; 705/14.26

(57) ABSTRACT

A system of electronically requesting, generating and processing a coupon over a payment processing network is provided. During a sales transaction, a purchaser at a point of sale (POS) terminal provides a customer identifier using a card with a magnetic stripe which is read by a magnetic card reader and then transmitted across the payment processing network along with product identifiers on the products being purchased. The customer identifier includes a banking identification number (BIN) which is read by a first server in the payment processing network and then forwarded to a coupon server. The coupon server uses the customer identifier and product identifier to select any coupons that are available for use by the purchaser and transmits the coupons back to the POS terminal, where the coupons are applied to the sales transaction.

### BACKGROUND

1. Field of the Invention

This invention relates to processing coupons electronically over a financial transaction network, and more particularly to requesting, generating, transmitting and processing coupons over a payment processing network during a payment process.

2. Description of Related Art

The use of coupons is difficult for both customers and merchants for many reasons. Customers using coupons during a purchase are generally required to bring a physical coupon to present to the merchant. Having to find, save and remember to bring the physical coupons to the merchant at the time that a product is being purchased is time-consuming and inconvenient for the consumer. Coupons often need to be organized by type, expiration date, the merchant's location where the coupon can be used, in addition to many other restrictions.

When the consumer does present the coupon to a merchant at the time of purchase, the coupon is manually scanned by a point of sale (POS) terminal, usually using an optical bar code reader which is configured to read a machine-readable code (ex. Universal Product Code (UPC)) present on the coupon. In some circumstances, the merchant will have to enter a coupon identification code into the POS if a UPC is not available or cannot be read. The merchant must also constantly update software for each POS terminal so that it has all of the possible coupons stored in a local database in order to determine if the coupons being presented are valid and can be accepted. The consumer is then given a discount on the purchase transaction immediately. However, if the coupon is from a manufacturer or seller of the purchased good or service, the merchant must request reimbursement for the cost of the coupon from that manufacturer. In order to process the coupon for reimbursement, the merchant must keep the physical coupons for separate processing, as the merchant is required to submit the coupons to a coupon processing center or the original manufacturer in order to be reimbursed for the coupon. The reimbursement process requires a significant amount of time for the merchant and often must be done daily or monthly in order to keep up with the amount of incoming coupons. The reimbursement process is tedious, prone to errors, costly and slow, as it may take weeks for a merchant to be reimbursed for the coupons it has accepted.

It is therefore difficult, inconvenient and time-consuming for the consumer and the merchant to use coupons.

### SUMMARY

Embodiments described herein are directed to systems and methods for requesting, generating, transmitting and processing coupons electronically over a payment processing network. At a point of sale (POS) terminal one or more products being purchased are scanned into the POS terminal, after which a coupon card with an electronic customer identifier is read by a magnetic or optical reader to obtain consumer identification information. The consumer identification information is then transmitted across a payment processing network in a format similar to a credit or debit card number along with information on the products being purchased, so that an initial processing server in the payment processing network routes the customer identification information and product information to a unique coupon server based on an identification code in the credit or debit card number, such as a banking identification number (BIN) number. The coupon server uses the consumer identification information and product information to identify any coupons that the customer can receive, and transmits coupon codes back to the POS terminal where the coupon is applied to the total amount due. A discounted total amount due is then determined, and the customer may then use any form of payment to pay for the transaction, including a credit card or debit card that uses the same payment processing network.

In one exemplary embodiment, a method of electronic processing of a coupon over a payment processing network comprises the steps of: obtaining a product identifier of at least one product; obtaining a customer identifier; transmitting the product identifier and the customer identifier over a payment processing network from a point of sale (POS) terminal to a coupon server, wherein at least a portion of the customer identifier is used as at least a portion of a payment processing destination address of the coupon server; identifying at least one coupon code applicable to the at least one product; transmitting the at least one coupon code to the POS terminal; and matching the at least one coupon code to the product identifier of the at least one product to apply a discount to the purchase price.

In another exemplary embodiment, a system of electronic processing of a coupon over a payment processing network comprises: a point of sale (POS) terminal communicatively coupled with the payment processing network; the POS terminal comprising: a product identification unit which obtains an identifier of at least one product; a customer identification unit which obtains a customer identifier; a transmission unit which receives the product identifier and the customer identifier from the product identification unit and customer identification unit and transmits the product identifier and customer identifier to the payment processing network; and a coupon server communicatively coupled with the payment processing network, comprising: a coupon code matching unit which selects at least one coupon code associated with the at least one product identifier; a coupon code transmission unit which transmits the at least one coupon code to the POS terminal for application by the coupon code application unit; and a coupon code application unit which applies at least one coupon code to a transaction to purchase at least one product.

In a further exemplary embodiment, a method of electronic processing of a coupon at a point of sale (POS) terminal comprises the steps of: initiating a purchase transaction; obtaining at least one product identifier; obtaining a customer identifier; parsing the customer identifier to obtain a purchaser identification number and a bank identification number (BIN); generating a payment processing network transaction comprising a banking identification number (BIN) as at least a portion of a n address, the purchaser identification number and the at least one product identifier; sending the payment processing transaction over a payment processing network; pausing the purchase transaction; receiving an associated coupon code via the payment processing network with at least one of the at least one product identifiers; resuming the purchase transaction; and applying the coupon code to the purchase transaction.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system for electronic processing of a coupon over a payment processing network, according to one embodiment of the invention;

FIG. 2 illustrates a point of sale (POS) terminal configured for electronic processing of the coupon, according to one embodiment of the invention;

FIG. 3 illustrates a coupon server configured for electronic processing of the coupon, according to one embodiment of the invention;

FIG. 4 illustrates a method of electronic processing of a coupon over a payment processing network, according to one embodiment of the invention;

FIG. 5 illustrates another method of electronic processing of a coupon over a payment processing network, according to one embodiment of the invention; and

FIG. 6 is a block diagram that illustrates an embodiment of a computer/server system upon which an embodiment of the inventive methodology may be implemented.

### DETAILED DESCRIPTION

In the following detailed description, reference will be made to the accompanying drawings. The aforementioned accompanying drawings show by way of illustration, and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The embodiments described herein provide for systems and methods of requesting, generating, transmitting and processing coupons over a payment processing network. A purchaser is not required to find coupons in advance of the purchase or bring in a physical coupon. The purchaser may be assigned a unique customer identifier that is entered at a point of sale (POS) terminal at the time of purchase and transmitted over the payment processing network to a uniquely-configured coupon server. Product identifiers may also be transmitted along with the customer identifier so that coupons can be specifically selected based on the products being purchased or the merchant where the products are being purchased. The customer identifier may be formatted with a specified numerical prefix that allows it to be transmitted and routed through the payment processing network as if it was a payment processing transaction. Once the customer identifier is received at the coupon server, the coupon server will determine applicable coupon codes to apply to the identified products and transmit matching coupon codes back to the POS terminal over the payment processing network. The electronic coupons will then be received at the POS terminal and applied to the appropriate products by matching coupon identification codes to the product identification codes. Once a discounted total is determined, the purchaser may then enter a method of payment at the POS terminal, even paying with a debit, credit or gift card using the same payment processing network used to obtain the coupon.

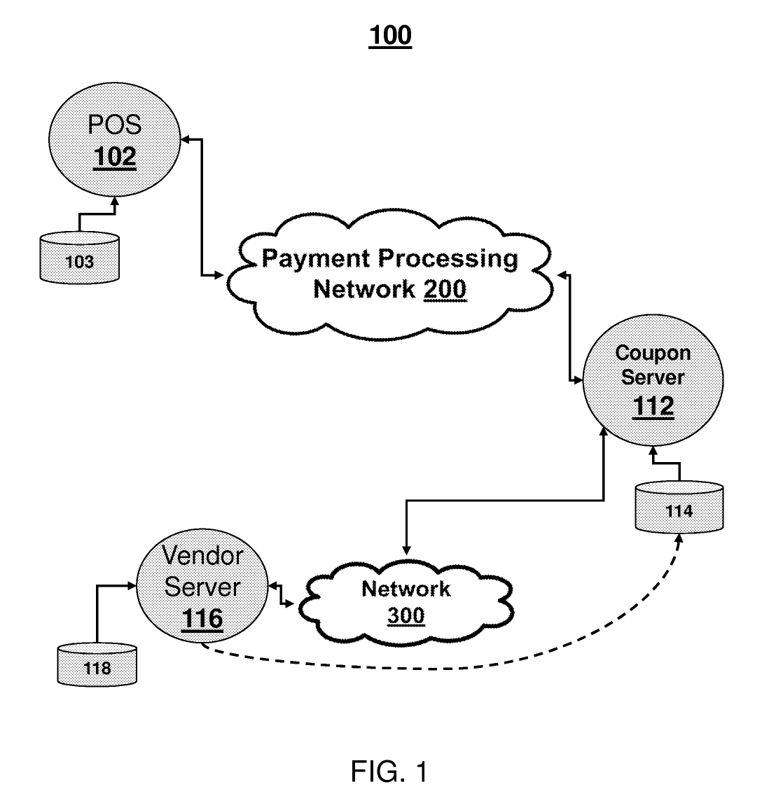

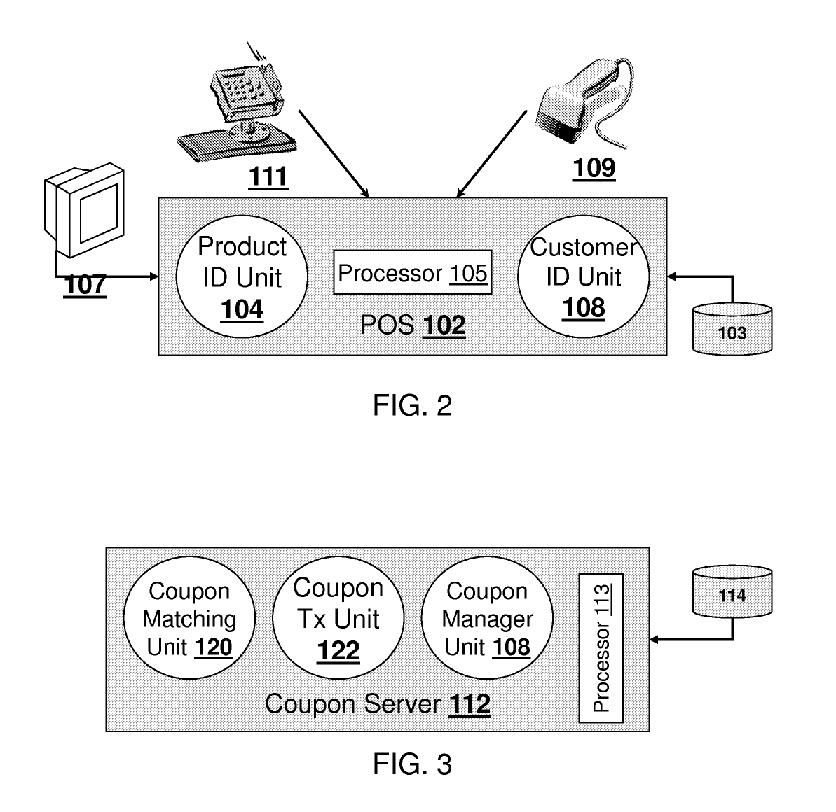

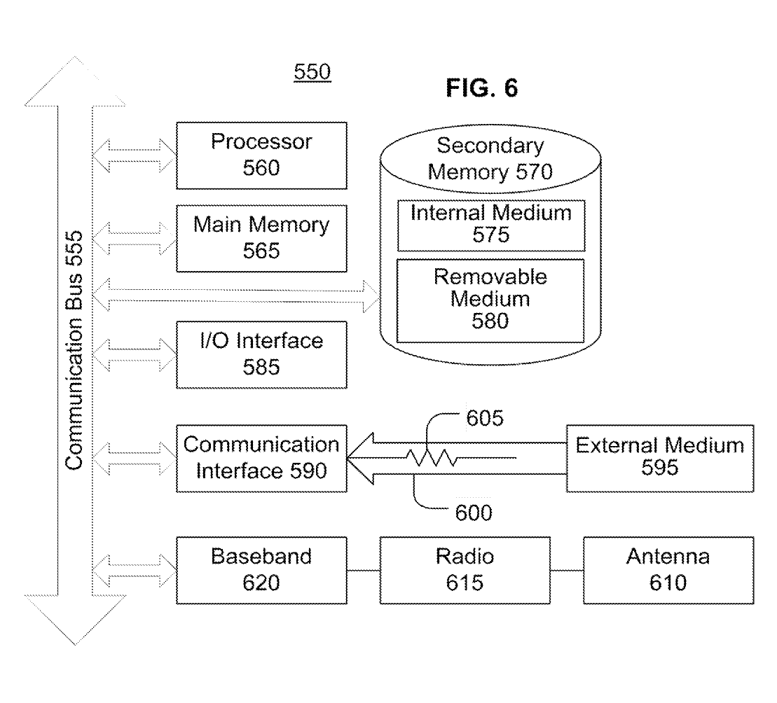

FIG. 1 is a block diagram of a system 100 for electronic processing of a coupon over a payment processing network, in accordance with one embodiment of the invention. A purchase transaction between a purchaser and a merchant begins at a point of sale (POS) terminal 102, where the purchaser brings at least one product to be purchased to the merchant in order to pay for the at least one product. The POS terminal 102 may be a computer with a memory, processor 105, attached display 107 and a plurality of input devices 109. A detailed configuration of the POS terminal 102 is illustrated by the computer system in FIG. 6 and described further below. A database 103 connected with the POS terminal 102 may store information needed to carry out a purchase transaction. The product may be goods or services, but is not limited thereto. As shown in FIG. 2, several software units may be provided at the POS terminal 102, including a product identification unit 104 that will obtain a product identifier to identify the at least one product being purchased using the input device 109 to input the product identifier. In one embodiment, one type of input device 109 is an optical scanner which optically reads a bar code, such as a Universal Product Code (UPC). The POS terminal 102 will look up the bar code in the database 103 to identify the product and the price.

Once the product or products have been identified, the purchaser may present a customer identifier which may be read by a customer identification unit 108 at the POS terminal 102. In one embodiment, the customer identifier is a number which may be stored on a plastic card with a magnetic strip similar to a credit card, so that the customer identifier may be read by an input device 109 such as a magnetic card reader 111 connected with the POS terminal 102. In another embodiment, the customer identifier may be stored on a card with an RFID or NFC transmitter and read by an appropriately configured input device 109. In a further embodiment, the customer identifier may be stored electronically on a portable electronic device, such as a smartphone or tablet, where it may be displayed on a display screen of the portable electronic device or transmitted to the POS terminal 102 using wireless or optical transmission, such as infrared, Bluetooth®, WiFi, RFID, NFC, etc. In addition, in one embodiment, the customer identifier may be integrated with an application or program running on the portable electronic device, and may be integrated with a mobile payment service such as Google Wallet®. The customer identifier may include a number unique to the purchaser, a membership club, company, or any organization which may provide coupons. The customer identifier may also include additional information on a type of membership level, benefits or other purchaser profile information.

In one embodiment, the customer identifier is formatted in order to be read and understood by servers on a payment processing network 200. The customer identifier may therefore include a banking identification number (BIN) in the first five or six digits of a numerical sequence, as the BIN will indicate to the payment processing network 200 where the customer identifier and related purchase information should be sent in order to obtain one or more electronic coupons.

The customer identifier and purchase identifiers are then transmitted from the POS terminal 102 on the payment processing network 200, as understood by one of skill in the art, to a coupon server 112, which is the identified destination extracted from the BIN. The payment processing network 200 identifies the BIN number in the incoming transmission and then accesses a database of all of the names and server addresses of all possible entities which belong to the payment processing network 200, such as credit, debit or gift card issuers that may have issued a credit, debit or gift card. In one embodiment, the BIN number in the customer identifier corresponds to the coupon server 112, which may be managed by an entity responsible for generating, matching and transmitting coupons. The BIN number is then matched with the corresponding entity managing the coupon server 112, after which the payment processing network 200 identifies the server address of the coupon server 112 and transmits the customer identifier and product identifier to the coupon server 112.

The coupon server 112 may be a computer with a memory and processor 113, a detailed configuration of which is illustrated by the computer system in FIG. 6 and described in further detail below. The coupon server 112 uses the customer identifier and product identifier to match appropriate coupon codes which correspond to the products being purchased, the merchant where the products are being purchased or even to a specific purchaser. For example, a coupon code may pertain to a specific product, all products of a specific brand, a specific merchant, etc, as determined by UPC coupon codes or otherwise. As described above, the customer identifier and product identifier may contain unique numerical codes corresponding to a specific purchaser, the specific products, the specific merchant, etc. As illustrated in FIG. 3, the coupon server 112 will access a coupon database 114 which stores information on the coupons, purchasers, merchants and the rights that purchasers have to access specific coupons. The coupons may be restricted or provided based on any type of criteria, including purchaser location, time, type of merchant, number of products being purchased, purchasing history, merchant promotions, purchaser memberships in discount clubs or organizations, etc. The coupon database 114 may also store the plurality of rules and restrictions in addition to the coupons themselves, and a coupon matching unit 120 at the coupon server 112 will then use the customer identifier, product identifiers and any other information to determine the coupons that should be provided to the customer.

Once the coupons are selected by the coupon matching unit 120, coupon codes corresponding to each coupon are transmitted by a coupon server transmission unit 122 at the coupon server 112 back to the POS terminal 102. The coupons are therefore electronic and are transmitted in the form of unique coupon codes, in the form of UPC codes or otherwise, that can be translated by the POS terminal 102 into the specific discount or promotion to apply to the purchase. In one embodiment, the process of transmitting the customer identifier and purchase identifier across the payment processing network 200 is asynchronous, in that the POS terminal 102 which transmits the identifiers will await a response from the coupon server 112 before continuing to process the transaction. The payment processing network 200 may also operate asynchronously and await a response from the coupon server 112 once the identifiers are transmitted, which will make it easy for the payment processing network 200 to identify where to send the selected coupons codes that are received from the coupon server 112.

Once the POS terminal 102 receives the selected coupon codes, the POS terminal 102 inputs the coupon codes, matches the coupon codes to associated product codes, and applies the appropriate discounts to the products being purchased. When the discounted total purchase amount is determined, the POS terminal 102 may then complete the payment of the purchase as it normally would, for example by accepting payment from the purchaser using a credit, debit or gift card that is swiped at an input device 109 such as the magnetic card reader 111, and then transmitted by the POS terminal 102 across the payment processing network 200 to an authorizer at a banking server to complete a normal payment process.

In one embodiment, the POS terminal 102 may be configured with specific software that will recognize the input of the customer identifier at an input device 109 such as the magnetic card reader 111. The software may be installed along with existing POS terminal software as an add-on or patch to the existing POS terminal software, or the POS terminal 102 may be loaded with proprietary software which includes the capability to recognize the customer identifiers and transmit the customer identifier, product identifiers and other relevant purchase information across the payment processing network 200.

In one embodiment, a vendor may interact with the coupon server 112 remotely over a network 300, such as the Internet, in order to create and manage coupons. The coupon server 112 may therefore provide a remote user interface where the vendor can access the list of current coupons to create new coupons, delete old or expired coupons and manage access to coupons based on one or more factors. In an alternate embodiment, the coupon server 112 may be connected with one or more vendor servers 116 over a separate network 300, such as the Internet, in order to electronically receive updated lists of coupons. The vendor server 116 may be operated by a product manufacturer which is responsible for creating the coupons. The vendor server 116 may then create and store a list of valid coupons in its database 118, and the coupon server 112 may then request or automatically receive the latest updated coupons from the vendor server 116. In one embodiment, the vendor server 116 may communicate directly with the coupon database 114 to update the list of coupons available to consumers, or, the vendor server 116 could be located within the coupon server 112.

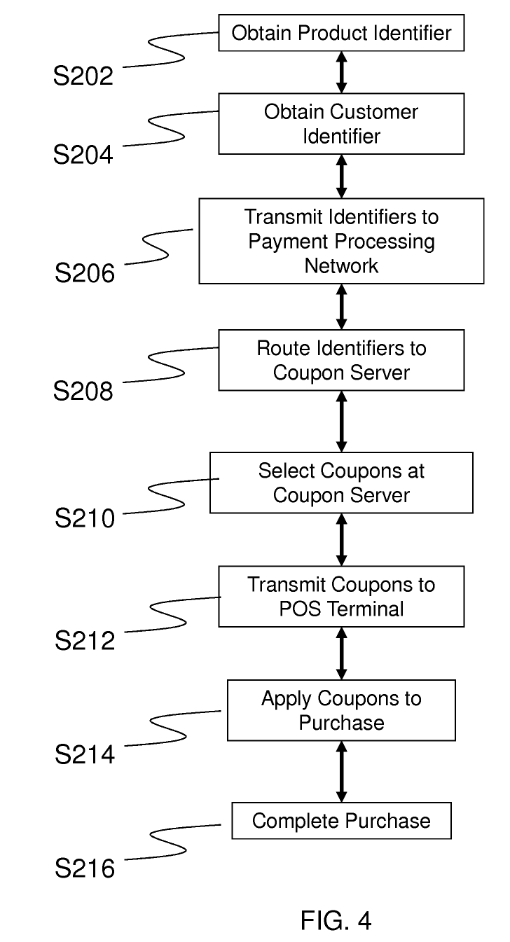

FIG. 4 illustrates one embodiment of a method of electronic processing of a coupon over a payment processing network. In a first step S202, a product identifier is obtained for at least one product. In a second step S204, a customer identifier is obtained. Next, in step S206, the product identifier and customer identifier are transmitted over a payment processing network from a point of sale (POS) terminal to a coupon server. In step S208, at least a portion of the customer identifier is used as at least a portion of a payment processing destination address in order to route the identifiers to a coupon server. At least one coupon applicable to the at least one product is selected at the coupon server in step S210, after which, in step S212, the at least one selected coupon is transmitted to the POS terminal. In step S214, the at least one selected coupon is applied to a price of the at least one product, after which the purchaser may complete the purchase (S216) by any form of payment method, even by using the same payment processing network used to obtain the at least one selected coupon.

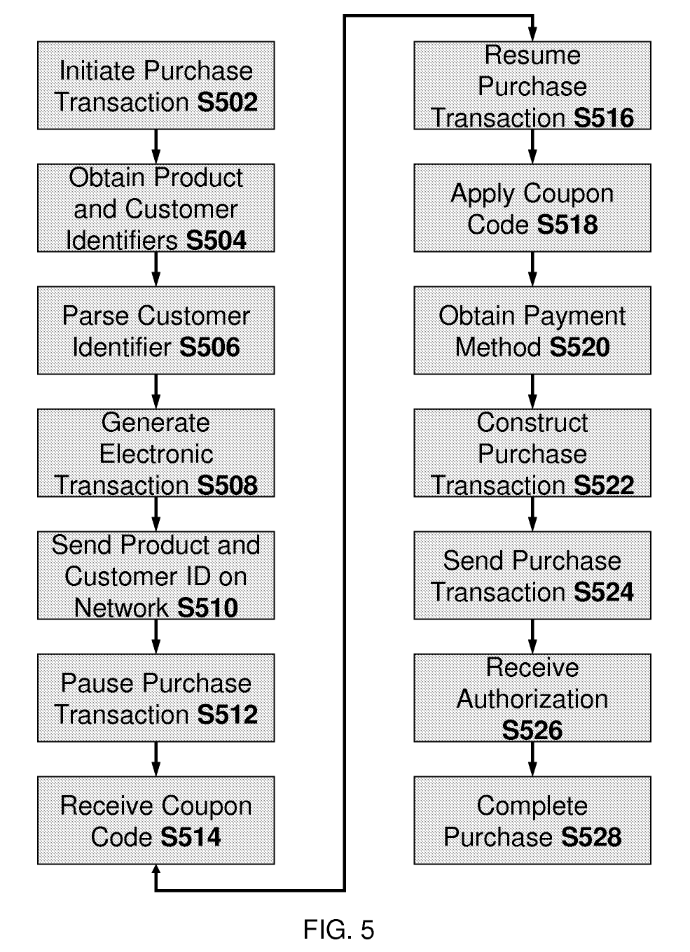

FIG. 5 illustrates another embodiment of a method of electronic processing of a coupon over the payment processing network. In a first step S502, a purchase transaction is initiated at the POS terminal. Next (S504), a product identifier is obtained, such as by scanning a UPC code on a product tag, and a customer identifier is obtained, such as by scanning a special coupon card with a barcode, magnetic strip or other type of machine-readable code. In step S506, the customer identifier is parsed to obtain a customer identification number and a bank identification number (BIN). A payment processing network transaction may then be generated (S508) comprising the BIN, customer identification number and product identifier. The BIN may contain at least a portion of an address which corresponds to the destination address for the payment processing network transaction. The payment processing network transaction is then sent over the payment processing network in step S510. Meanwhile, the purchase transaction is paused (S512) while the payment processing network transaction is being carried out. One or more coupon codes are received from the coupon server in step S514, after which the payment processing network transaction is resumed (S516). Next, in step S518, one or more of the coupon codes are applied to the purchase transaction in order to discount the purchase price of the products being purchased. Once the discounts are applied, a payment process is initiated where a method of payment, such as a credit, debit or gift card number, is obtained from the customer (S520), a purchase transaction is constructed (S522). The purchase transaction is sent across the payment processing network (S524) to a banking server to authorize the use of the method of payment, authorization is received (S526) and the purchase is completed (S528).

### Computer-Implemented Embodiment

FIG. 6 is a block diagram illustrating an example wired or wireless system 550 that may be used in connection with various embodiments described herein. For example the system 550 may be used as or in conjunction with the system 100 for electronic processing of a coupon as previously described with respect to FIGS. 1-3. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A method of electronic processing of a coupon over a payment processing network, comprising the steps of:
obtaining a product identifier of at least one product;
obtaining a customer identifier;
transmitting the product identifier and the customer identifier over a payment processing network from a point of sale (POS) terminal to a coupon server, wherein at least a portion of the customer identifier is used as at least a portion of a payment processing destination address of the coupon server;
identifying at least one coupon code applicable to the at least one product;
transmitting the at least one coupon code to the POS terminal; and
matching the at least one coupon code to the product identifier of the at least one product to apply the coupon to the at least one product.

2. The method of claim 1, wherein the customer identifier includes a banking identification number (BIN).

3. The method of claim 2, wherein the BIN is the portion of the customer identifier used as the payment processing destination address.

4. The method of claim 3, wherein the customer identifier includes a purchaser identification number.

5. The method of claim 1, wherein the coupon server identifies at least one coupon code applicable to the at least one product by matching the at least one product identifier with any applicable coupon code.

6. The method of claim 1, wherein the product identifier is a universal product code (UPC).

7. The method of claim 1, further comprising obtaining the customer identifier by reading a magnetic strip with a magnetic card reader.

8. The method of claim 1, further comprising obtaining the customer identifier by reading a barcode with a barcode reader.

9. The method of claim 1, further comprising completing a transaction to purchase the at least one product.

10. A system for electronic processing of a coupon over a payment processing network, comprising:
a point of sale (POS) terminal communicatively coupled with the payment processing network; the POS terminal comprising:
a product identification unit which obtains an identifier of at least one product;
a customer identification unit which obtains a customer identifier;
a transmission unit which receives the product identifier and the customer identifier from the product identification unit and customer identification unit and transmits the product identifier and customer identifier to the payment processing network; and
a coupon code application unit which applies at least one coupon code to a transaction to purchase at least one product; and
a coupon server communicatively coupled with the payment processing network, comprising:
a coupon selection unit which selects at least one coupon code associated with the at least one product identifier; and
a coupon code transmission unit which transmits the at least one coupon code to the POS terminal for application by the coupon code application unit.

11. The system of claim 10, wherein the customer identifier includes a banking identification number (BIN).

12. The system of claim 11, wherein the BIN includes a portion of a destination address of the coupon server on the payment processing network.

13. The system of claim 12, wherein the customer identifier includes a purchaser identification number.

14. The system of claim 10, wherein the coupon selection unit selects the at least one coupon code associated with the at least one product identifier based on the product identification number.

15. The system of claim 14, wherein the product identifier is a universal product code (UPC).

16. The system of claim 14, wherein the coupon code is in the format of a universal product code (UPC).

17. The system of claim 10, wherein the customer identification unit obtains the customer identifier by reading a magnetic strip with a magnetic card reader.

18. The system of claim 10, wherein the customer identification unit obtains the customer identifier by reading a barcode with a barcode reader.

19. A method of electronic processing of a coupon at a point of sale (POS) terminal, comprising:
initiating a purchase transaction;
obtaining at least one product identifier;
obtaining a customer identifier;
parsing the customer identifier to obtain a purchaser identification number and a bank identification number (BIN);
generating a payment processing network transaction comprising a banking identification number (BIN) as at least a portion of a destination address, the purchaser identification number and the at least one product identifier;
sending the at least one product identifier and customer identifier over a payment processing network to a coupon server;
pausing the purchase transaction;
receiving a coupon code associated with the at least one product identifier from the coupon server;
transmitting coupon codes over the payment processing network with at least one of the coupon codes associated with the at least one product identifier;
resuming the purchase transaction; and
applying the at least one coupon code to the purchase transaction.

20. The method of claim 19, further comprising:
obtaining a credit, debit or gift card number;
constructing the purchase transaction;
sending the purchase transaction over the payment processing network;
receiving authorization for the purchase transaction from the payment processing network; and
completing the purchase transaction.

21. The method of claim 20, further comprising:
constructing the purchase transaction;
applying a cash payment to the purchase transaction; and
completing the purchase transaction.
